(19) United States
(12) Patent Application Publication
(10) Pub. No.: US 2003/0122752 A1
(43) Pub. Date: Jul. 3, 2003

(54) Localized driving means for cholesterics displays

(76) Inventor: Yao-Dong Ma, San Jose, CA (US)

Correspondence Address: Yao-Dong Ma, 1866 Bethany Ave, San Jose, CA, 95132, US

(21) Appl. No.: 10/040,078

(22) Filed: Jan. 3, 2002

(51) Int. Cl. G09G 3/36

(52) U.S. Cl. 345/87

(57) ABSTRACT

A localized driving means for cholesteric liquid crystal display comprises a high erasing pulse; a low addressing pulse and a series bias voltage pulses with its amplitude not less than a threshold voltage from planar to focal conic structure. The erasing pulse and the addressing pulse, superimposed to the bias pulses, are applied to a predetermined location at the same time, whereby the unstable planar state and the unstable focal conic state are displayed simultaneously in at least a partial area of the display during the addressing; whereby an stable planar state and an stable focal conic state are displayed simultaneously in at least a partial area of the display by the end of the addressing process.

### FIELD OF THE INVENTION

This invention relates to a driving means for liquid crystal display, especially to a driving means for localized addressing cholesteric liquid crystal displays where requires fast switching speed at low power consumption. The waveform also generates high quality images with an excellent contrast ratio.

### BACKGROUND OF THE INVENTION

Cholesteric liquid crystal is the earliest mesomorphic state of matter known to humankind. Cholesteric liquid crystal display (ChLCD) is a sort of Cinderella in the liquid crystal family, an old but state-of-the-art technology that started 30 years ago when people found Electric Field Induced Phase Change Effect of the cholesteric liquid crystal displays. It is characterized by the fact that the pictures may stay on the display even if the driving voltage is disconnected. The bistability also ensures a completely flicker-free display and has the possibility of infinite multiplexing to create giant displays and/or ultra-high resolution displays. The Bragg scattering effect makes ChLCD the best candidate for the reflective color display if the pitch of the ChLC is chosen in the range of visible wavelength. However, for the reasons of high driving voltage, especially the high instant driving power consumption and slow driving means, which make it impossible for the animation display and thereafter the poor electro-optical performance. Therefore, it has been replaced by other displays such as twist nematic (TN) and super twist nematic (STN). Almost no one has mentioned about the cholesteric LCD until recent years' discovery of new display modes and improvements of the driving methods.

In the article of “Storage-Type Liquid Crystal Matrix Display” (SID 79 Digest, p.114-115) Tani proposes a driving method for the ChLCD. The display adopts a vertical alignment treatment and the liquid crystal pixel can be driven from stable planar structure to stable focal conic structure or from stable focal-conic structure to stable planar structure depending on the pre-designed waveform. The storage type display has the advantages of long storage time, which makes refreshing or updating of the information on the display unnecessary. However the scanning speed is relatively slow and each line needs 8 ms to address the pixels and the information can not display till the whole frame scanning is accomplished. The power consumption is high because of the two phase change voltages to the non-selection pixel and multi driving pulse sequence are over the phase change (untwist threshold) voltage.

U.S. Pat. No. 5,644,330 introduces a driving method based on static electro-optical curve of ChLCD by defining V₁ as the first threshold voltage; V₂ as the first saturate voltage; V₃ as the second threshold voltage; and V₄ as the second saturate voltage. The voltage sequence or driving waveform could drive the display from one cholesteric stable state to the other. A pulse higher than V₄ can drive the display into planar state while a pulse V₄ and followed by a pulse between V₂-V₃ will drive the display into the focal-conic state. Though the static driving principle is the same as Tani's approach, “330” teaches two bipolar square waveforms exerting to X,Y electrodes separately. When the two bipolar waveform is out-phase, the resultant voltage will be high enough to drive the display to planar state while the in-phase resultant voltage will drive the display into the focal conic state instead. Again the driving waveform is based on the static approach, i.e., the pulse width should be wide enough to drive the display from one stable state to the other stable state. As a result the scanning speed is very slow.

U.S. Pat. No. 5,748,277 divides the information writing into three stages, i.e., preparation, selection and evolution. In the first preparation phase, a pulse or series of pulses causes the liquid crystal within the picture element to align in homeotropic state and the display looks dark. The second stage is named selection step, during which the voltage added to the liquid crystal within the picture element is chosen so that the final optical state of the pixel will be either focal conic or twisted planar. In practice, the voltage is chosen to either maintain the homeotropic state or reduced enough to initiate a transition to the transient twisted planar state. The third stage is evolution step, during which the liquid crystal selected to transform into the transient twisted planar state during the selection step now evolves in a focal conic state and the liquid crystal selected to remain in the homeotropic state during the selection phase continues in the homeotropic state. The voltage level of the evolution phase must be high enough to maintain the homeotropic state and permit the transient planar state to evolve into the focal conic state. After evolution stage, there comes actually holding stage where the voltage is taken to near zero or removed entirely from the pixel. The liquid crystal domains that are in the focal conic state remain in the focal conic state and those in the homeotropic state transform into a stable light reflecting planar state. In other words, the information can not be recorded till the completion of the holding stage. The bipolar waveform makes the driver circuitry very complicated and long time in maintaining homeotropic state by multiple high voltage pulses which cause the power consumption relatively high and the display takes on dark background.

U.S. Pat. No. 5,625,477 teaches a driving means of whole frame erasing and line to line addressing. The waveform for the erasing stage consists of two pulses: first high voltage and followed by a low voltage pulse. The first high voltage pulse, which is higher than the phase change voltage, induces the whole panel pixels into the field-induced-nematic state. Sequential low voltage pulse then guides the liquid crystal molecules of whole display panel from nematic state back to the stable cholesteric focal conic state or optical dark state because the display is painted black. After the whole frame is driven to dark state, there comes addressing stage. A second high voltage, which is over the phase change threshold voltage, is selectively added to the pixels into planar bright state. While the second high voltage pulse is applying to each pixel to be addressed, a second low voltage pulse is also applied to all the others during the line-to-line addressing. The driving means takes advantage of fast process from focal conic structure to the field-induced-nematic structure, then to the reflective planar structure, thus achieves fast driving speed. However, the fact that the information writing needs two high voltages, which is higher than the phase change threshold causes high power consumption. Furthermore the display works in a negative mode, i.e., write-bright-on-dark, a way of blackboard writing, therefore the black bar effect is inevitable for the large information content display. From human factor viewpoint, the reflective type display should be write-black-on-bright, a way of paper writing in order to maximize the display merit of environment light reflection. Such paper-writing mode is so popular that almost any liquid crystal panel with black bars is unacceptable. Another shortcoming of frame-erasing-line-to-line-addressing is that it can not be used as word editing, typewriting, or other instant input functions.

In the case of character writing display, according to different format, roughly more than half of the lines as spacing area doesn't need to be erased or recorded in the driving process. The frame-erasing-line-to-line addressing is not the best solution because of its slow driving speed (each line needs a minimum scanning time Tₛ and the frame scanning time T_{F} which is equal to Tₛ times number of the lines).

The basic formula (V_{R}−V_{S})/2=V_{N}<V_{T} tightly links three pulses, V_{R}, V_{S} and V_{N} together, which limits the effective addressing window. For example, if V_{R} needs to be increased to gain fast switching speed, V_{N} is also increased, which causes the cross-talk effect.

### SUMMARY OF THE INVENTION

The driving waveform is characterized with erasing pulse and writing pulse applied to the display's elements at the same time, which is totally different from traditional methods where the whole frame erasing was an essential prelude to a whole driving waveform. The present driving means is capable of directly writing the information without extra erasing time. In other words, regardless the optic state of the background, the new frame's information will be addressed onto the display panel within a short time period. The writing process of each pixel needs only one high voltage that over the phase transition point. The fast response time is achieved by the accumulated bias voltage which energizes liquid crystal molecules in a dynamic exciting state.

The display's driving waveform is also characterized by the new formula, V_{N}>V_{T}, which means that the bias voltage is set higher than the planar-to-focal-conic transition voltage. Under the bias voltage the display appears a special optical states:

1) Unstable focal conic structure

The focal conic structure area under the high bias voltage is excited focal conic texture. There is no any Bragg reflection, and the liquid crystal takes on strong scattering state. The capability of light scattering is actually stronger than the static focal conic texture (optical enhancement effect). Thus the efficiency of depolarization is higher than that of the static focal conic texture. This phenomenon is somewhat similar to the dynamic scattering of the nematic liquid crystal with negative birefringence. There is more molecular randomness in such unstable structure than in the static focal conic texture. To drive ChLC into unstable focal conic structure, a relative high voltage pulse is needed. Unlike static focal conic texture where the molecules have the minimum systematic energy, the unstable focal conic structure obviously has high bulk energy. When the voltage withdraws from the display, the light scattering is getting weak and the ChLC will be getting back to the stable focal conic structure. This optical state, in the current invention, is termed unstable focal conic structure.

2) Unstable planar structure

Under the influence of the bias voltage, the designated planar texture area is no longer a pure planar texture. The pixels look milky white when the intrinsic pitch is adjusted in the invisible wavelength, and are of feeble colored when the pitch is adjusted in the visible wavelength. For example, if the static planar texture looks bright green, then the unstable planar structure takes on a dark green. The average orientation of the cholesterics axis in unstable planar structure is tilt to a certain degree off the normal direction of the surface. There is no bright reflection from any angle of view (optical weakening effect). When the bias voltage is withdrawn, the display will be back to the clear planar structure immediately. This optical state, in the current invention, is termed unstable planar structure.

There exists an electric field range that drives the planar structure to the unstable planar structure. This means that when the voltage withdraws from the display, the reflection will be back up to the original planar reflection within a short period. The liquid crystal molecules in the unstable planar structure are little randomized with its optical axis off the normal position to the substrate under electric-field condition. When the field is turned off, the restoring torch of the elastic force will turn the molecules to the planar structure, and the optical axis will be back to the normal position.

Dynamically, the bias voltage helps accelerating switching speed from planar texture to focal conic texture. The scheme of bias voltage is based upon the fact that when power off from the display pixels, ChLC with unstable planar texture will transit to its planar texture assuming that the voltage has not yet reached its saturate level. As a result, by the end of frame addressing or the completion of last line writing, the whole frame with unstable planar structure will transit to planar texture in the selected optical “on” area, while the unstable focal conic area that has been already displayed optical “off” state will transit to stable focal conic structure, continuing its optical “off” state. The high bias voltage facilitates the conversion from planar state to focal conic state.

High bias voltage is especially useful for the memory or storage type displays, such as electronic book and newspaper where video speed scanning is not necessary. And the high cross talk voltage remarkably shortens the pulse width of addressing. Note the bias voltage herein has fundamental difference between traditional hysteretic bias voltage driving scheme, where the bistability of the display relies on the bias voltage arranged at the center of the hysteresis loop. The present invention, however, is of zero field bistability.

The present invention provides a feature of partial writing capability. This is the case when only the localized pixel, single line or multiple lines need to be addressed for changing its information while others are maintaining their original information content. There are two cases in this perspective. First, it has always some spacing pixels between two information lines in an article that never needs to be addressed. It is necessary to escape from those lines where there is no in-line character during information writing process. Thus shorten the writing time and speed up refreshing time. An article will be able to be partially revised within a page. Other functions such as data inputting and typewriting will also be able to implement in one portion of the display while other portion is maintaining the preceding information content. However, the partial writing time is a variable depending on the integral multiplication of scanning lines (characters to be revised) and line addressing time, which is different from line space escaping mode. Such driving means remarkably speed up word processing.

Secondly, in a moving picture display, sometimes a moving part is only a fraction of the whole picture while the rest part is static. In this case only the moving part needs to be addressed. This feature may result in a video rate display. Obviously, both the character display and picture image display requires the partial driving means. The advantage over the prior art is stemming from the elimination of the whole-frame-erasing process where the partial erasing and writing is impossible.

With the help of the bias voltage, the response time from planar texture to focal conic texture is remarkably shortened. A short pulse with lower voltage will be able to address all the pixels to selected optical “off” state. Meanwhile, a short pulse with higher voltage pulse will drive the display pixels into optical “on” state. The latter is high enough to drive liquid crystal molecules from cholesteric phase to field-induced-nematic phase. In reality, the driving pulses of both voltages are of the same pulse width but different height. The driving waveform is actually synthesized by X and Y waveforms. The X and Y drivers can be polar waveform generator or bipolar one. For economic reason, polar driver is preferred.

From undisturbed planar structure, an electric pulse is applied on the display area with an incremental scale-up. When the voltage is below the threshold, V_{T}, there is no substantial optical change. Liquid crystal molecules will be remaining its original structure, i.e., with its optical axis vertical to the substrate. However, when the voltage has reached up to the threshold level, the planar reflection will be decreased. There are two voltage ranges above the threshold, “unstable” planar structure and “stable” focal conic structure.

### BASIC DYNAMIC DRIVING MEANS

If a bias voltage, which sets in the range of the above-mentioned unstable planar structure, and which is also superimposed with a high voltage erasing pulse and a low voltage writing pulse, is applied onto all the display element, a basic dynamic driving means will come into being.

1. Unstable Planar Structure to Unstable Focal Conic Structure

To drive the display from unstable planar structure to unstable focal conic structure, a low voltage writing pulse will be added to the bias voltage level, which triggers a dynamic scattering. After the writing pulse is off, the voltage is decreased to the bias level and the ChLC converts to unstable focal conic structure. The unstable focal conic structure has much more depolarization effect than that of stable focal conic structure, which can be used for some special applications.

2. Unstable Focal Conic Structure to Unstable Planar Structure

To drive the display from unstable focal conic structure to the unstable planar structure, a high voltage pulse is added to the bias voltage level, which is powerful enough to drive the molecules from cholesteric phase to field-induced-nematic phase. When the pulse is off, the driving voltage is back to the bias level and then the molecules will relax from nematic to cholesteric unstable planar structure.

3. Stable Focal Conic Structure and Stable Planar Structure (Bistable Memory)

After the whole frame addressing has finished through line-to-line scanning, the bias voltage level will be withdrawn, thus the stable planar structure will be built up within a short time. And the stable focal conic structure has already been formed during the scanning process. As a result, a static picture or image will be obtained.

### PARTIAL OR LOCALIZED DRIVING MEANS

In the localized addressing mode, the addressing voltage and the erasing voltage are no longer always applied to the first line of the display panel, and the addressing voltage and the erasing voltage are no longer always applied to the last line of the display panel, either. However, the whole frame will have the same base line V_{NP}. The addressing voltage and the erasing voltage may start from any area in the character display and from any line in the picture display. The localized driving means allows partial different word processing, typewriting and data inputting. The information content to be partially processed can be based on one pixel, one line or multiple lines, while the rest information contents are maintaining in their originals in the display area. There are two scenarios in this perspective. Firstly, there are always some spacing lines between two information lines in an article that never need to be addressed. Such lines will be escaped from scanning during information writing process. Thus remarkably shorten the writing time and speed up the refreshing time. It is also very useful when an article needs to be partially revised within a whole frame while the other part is keeping the previous information content in the same frame. Such driving means remarkably speed up the refreshing process. Secondly, in the picture display, some moving part is only a fraction of the whole picture while the background is static. In this case only the moving part needs to be addressed. This feature results in a video rate display. The partial writing time is based on how many pixels are needed to be addressed. Obviously both the character display and the picture image display require the partial or localized driving means. The advantage over the prior art is derived from the elimination of the whole-frame-erasing-line-to-line addressing where the partial erasing and writing process is impossible.

### BRIEF DESCRIPTION OF DRAWING

FIG. 1 illustrates electro-optical curve and the definition of unstable cholesteric states.

FIG. 2 illustrates the driving waveform

FIG. 3 illustrates the composition of the waveform

FIG. 4 illustrates the power supply distribution circuitry

### DETAILED DESCRIPTION OF DRAWING

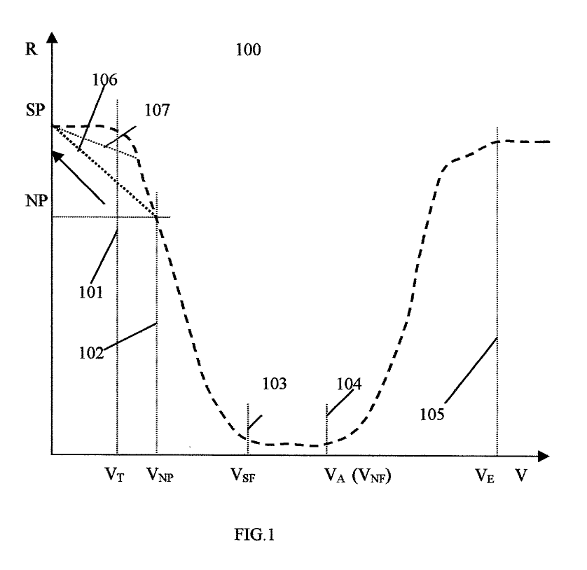

First referring to FIG. 1, illustrated is electro-optical curve of a cholesteric liquid crystal display. It represents optical response (reflectivity) to the electric field. Starting from undisturbed planar structure and zero voltage, an electric pulse is applied on the display area with an incremental scale-up. Thus the responsive reflection will generate a curve, 100. “SP” means stable planar state and “NP” unstable planar state. From the curve, it is not difficult to realize that when the external voltage is smaller than V_{T} 101, reflectivity of the reflective display will substantially remain the same. But, when the voltage is over V_{T} to a certain level, i.e., V_{SF} 103, the reflectivity of it will decrease accordingly. The present invention introduces an important voltage level V_{NP}, 102, ranging from V_{T} to V_{SF} in the falling section of the curve. Optical reflection corresponding to V_{SF} is “NP”, which obviously has less reflectivity than that the stable planar state. In other words, when the electric field is below the threshold, V_{T}, 101, there is no substantial optical change. Liquid crystal molecules will be remaining its original structure, i.e., with its optical axis vertical to the substrate. However, when the voltage has reached above the threshold level, the planar reflection will be reduced. There are two voltages above the threshold in the falling section of the curve 100, “unstable” planar structure V_{NP}, 102 and “stable” focal conic structure V_{SF} 103. If the bias voltage of the driving circuit is chosen at V_{NP}, 102 during addressing, the bias voltage is withdrawn to zero by the end of addressing, the reflection will be back-up to the stable planar state “SP” through a fast path 106 or 107 depending on different applications. The fast path 106 is more suitable for the whole frame addressing mode, while the fast path 107 is more suitable for the localized addressing mode. This will be described later in the following section. The arrow direction shown in the curve reflects the back-up process, which is facilitated with the help of the surface alignment effect of the substrates. Herein the surface condition plays an important part of such driving means. Both the single layer rubbing and double layer rubbing will create the reflection enhancement effect. However, taking the display performances into overall consideration, the single layer rubbing is preferred. It is also discovered that to obtain the best display result, the rubbing substrate should positioned at the backside of the display, opposite to the viewing side. With the voltage level going up to V_{NF} 104, the scattering effect of the cholesteric focal conic reaches its maximum due to the disturbing of the liquid crystal molecules. Depolarization effect, therefore, also reaches the highest point. The voltage V_{NF} 104 can be used as addressing voltage V_{A}, and this will be described in detail later. With the voltage increasing, liquid crystal molecules will be undergone a phase change, to field-induced-nematic phase. Here comes the other important point called erasing voltage V_{E} 105 where the optical reflectivity reaches the highest if the voltage is suddenly withdrawn to zero.

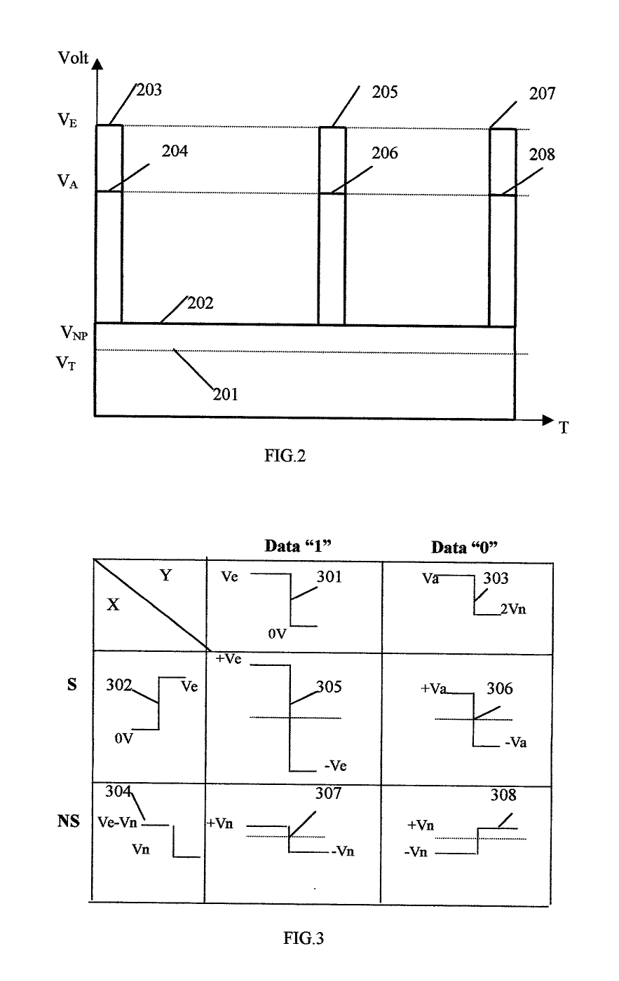

Turning now to FIG. 2, illustrated is the driving waveform of the invention. The base line of the waveform is set to V_{NP} 202, which is higher than the voltage V_{T} 201, a fundamentally different from the prior art where the working point always set below the voltage V_{T} 201. With the help of base line or bias voltage V_{NP} 202, addressing speed will be much faster than that of the prior art. It is noticed from the waveform that only one high voltage, which is over the field-induced-nematic phase change voltage has been utilized for the purpose of pixels addressing in the present invention.

Whole Frame Addressing Mode

Starting from the first line's addressing, both the addressing voltage 204 and the erasing voltage 203 may be added on the display pixels depending on what information needs to be written to the display panel. Writing and erasing will be carried out simultaneously no matter what previous information was (planar structure or focal conic structure). During the addressing process, the optical “on” state energized by erasing voltage 205 will be in unstable planar state with the reflectivity “NP” instead of “SP”. The optical “off” state energized by addressing voltage 204 will be in unstable focal conic state. When the addressing process reaches the last line of the frame, the optical “on” state energized by erasing voltage 207 will become stable planar state “SP”, and the optical “off” state energized by addressing voltage 206 will be in sable focal conic state. At the same time, all the optical “on” state in the previous lines within the same frame will also become stable planar state “SP”. The display look brighter all of sudden when the final line's addressing has just been finished. The difference of the reflectivity of stable planar and unstable planar is a function of bias voltage. Higher bias voltage delivers fast addressing speed but higher difference in reflectivity between the two states. In the whole frame-addressing mode, such as an electronic reader display, the main concerning factor is the frame speed. Therefore it is preferred to adopt higher bias voltage to obtain fast addressing speed, which is shown in the fast path 106 in FIG. 1.

Partial or Localized Addressing Mode

In the localized addressing mode, the addressing voltage 204 and the erasing voltage 203 are no longer always applied to the first line of the display panel, and the addressing voltage 206 and the erasing voltage 207 are one longer always applied to the last line of the display panel, either. However, the whole frame will have the same base line V_{NP} 202. The addressing voltage 204 and the erasing voltage 203 may start from the first spacing area in the character display and the first line needed to be revised in the picture display. Similarly, addressing voltage 206 and the erasing voltage 207 may be applied to the last spacing area of the character display and the last line needed to be revised of the picture display. The localized driving mode allows partial writing or changing the information content based on one pixel, one line or multiple lines while the rest information contents are maintaining their originals in the display area. There are two scenarios in this perspective. First, there are always some spacing lines between two information lines in an article that never need to be addressed. Such lines without characters will be escaped from scanning during information writing process. Thus remarkably shorten the writing time and speed up the refreshing time. It is also very useful when an article needs to be partially revised within a whole frame while the other part is keeping the previous information content in the same frame. Such driving means remarkably speed up refreshing process. Secondly, in the picture display some moving part is only a fraction of the whole picture. In such case only the moving part needs to be addressed. This feature results in a video rate display. The partial writing time is based on how many pixels are needed to be addressed. Obviously both the character display and the picture image display require the partial or localized driving means. The advantage over the prior art is derived from the elimination of the whole-frame-erasing-line-to-line addressing process where the partial erasing and writing process is impossible.

During the localized addressing, the frame response is not a main issue. The most important issue then is the same brightness between the freshly addressed pixel and the previous pixels, the contrast between the stable planar structure and unstable structure. In order to reduce such kind of contrast, the bias voltage needs to be decreased to a suitable level where both the addressing speed and contrast should be taken into account (see the fast path 107 shown in FIG. 1).

Liquid crystal material in the display cell structure also plays very important role in the localized addressing mode in terms of fast response time from unstable planar to the stable planar structure. The principle to make the LC formulation is low viscosity and high threshold voltage V_{T}.

Turning now to the FIG. 3, illustrated is waveform composition of the invention. During the addressing process, the DC waveform on the columns (Y driver) and the DC waveform on the rows (X driver) are in out-phase to form a AC waveform exerting to display's crossing dots or pixels, the intersection area of the X and Y electrodes.

The data “1” DC waveform out of Y driver 301 and the DC waveform on selected row 302 are of the same pulse height but opposite in phase and further composites a AC waveform 305 create optic “on” state, which drive the pixels to the unstable planar state during the scanning and to the stable planar state as the completion of the scanning process.

The data “1” DC waveform out of Y driver 301 and the DC waveform on non-selected row 304 are of different pulse height but in the same phase and further composites a AC waveform 307 to maintain both optic “on” and “off” states set before. Note the bias AC voltage V_{NP} is higher than the prior art “cross talk” voltage, which is less than V_{T}.

The data “0” DC waveform out of Y driver 303 and the DC waveform on selected row 302 are of different pulse height, and is different in phase. It composites a AC waveform 306 to create optic “off” state, which drives the pixels to unstable focal conic state during the scanning and to the stable focal conic state as the completion of the scanning process. In the prior art, of the whole frame erasing and line-to-line addressing the AC waveform 306 is useless or parasites pulse, yet the waveform 306 in the present invention is a driving force for the optic “off” state. More importantly, the high bias voltage V_{NP} acts as supplementary driving force, which reinforces the waveform 306 to drive ChLC material to the optic “off” state.

The data “0” DC waveform out of column Y driver 303 and the DC waveform out of non-selected row X driver 304 are of different pulse height but in the same phase, and it composites a AC waveform 308 to maintain both optic “on” and “off” states set before. In the prior art there is a series of parasitical “cross talk” pulses that is lower than V_{T}. Such cross talk voltage is nothing but a non-functional composition from borrowed STN drivers, which has always been trying to limit as low as possible. However, those skilled in the art take advantage of bias voltage V_{NP} that is higher than V_{T} and serves a positive effect to the driving means.

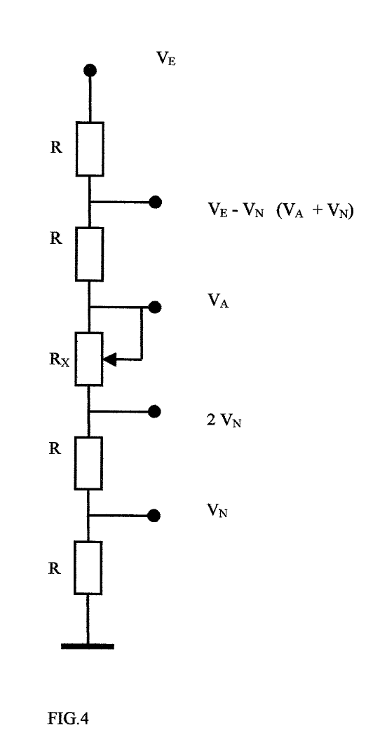

Turning now to FIG. 4, illustrated is the power supply distribution circuitry. V_{LCD} is the highest voltage of the LCD power source and herein equal to the erasing voltage V_{E}.

V_{E}=V_{LCD} (1)

A tunable resistor RX 503 is linked between the fixed resistors R₂ 502 and R₄ 504, while the fixed resistors R₁ 501 and R₅ 505 are connected to the ground and the power supply respectively. For fixed resistors, R₁, R₂, R₃ and R₄ have the same resistance and the voltage distribution of those in-series resistors results in an electronic divider circuit with multiple outputs, V_{NP}, 2V_{NP}, V_{A} and V_{A}+V_{NP}. V_{NP} is satisfied with the formula,

V_{NP}≧V_{T} (2)

V_{A} is satisfied with the equation,

V_{A}=V_{E}−2V_{NP} (3)

The three Equations mentioned above disclose an important principle of driving means. V_{A} and V_{NP} are not limited by V_{N} defined by the prior art. The higher V_{A} and V_{NP}, the faster writing speed will be obtained.

There are three fundamental differences compared with the prior art. First, Total electric pulses in the present invention is as half as the pulses that teaches in the prior art. Only one high voltage pulse, one low voltage pulse plus bias pulses are needed to activate a pixel to either optical “on” or “off” states while two higher voltages and two low voltages plus cross talk pulses are needed to drive a pixel to the related states in the prior art waveforms. Therefore, total power consumption will be substantially lower than the prior art.

Secondly, addressing time is shorter than that of the prior art. The present invention eliminates the whole frame addressing and thus save the time interval of one high pulse, one low pulse and one zero spacing time. As a result, total time of the one frame of the display will be reduced. Further more the novel waveform totally gets rid of the black line effect during the frame change which incurred in the prior art display.

Thirdly, software embedded in the display controller is getting simpler in the present invention, and related memory is much smaller than that of the prior art.

I claim:

1. A localized driving means for a cholesteric liquid crystal display comprising:
a. an erasing pulse with its pulse configuration sufficiently activating display elements to an unstable planar state;
b. an addressing pulse with its pulse configuration sufficiently activating display elements to an unstable focal conic state;
c. a bias voltage pulse with its amplitude not less than a threshold voltage from planar to focal conic structure.
the erasing pulse and the addressing pulse, superimposed to the bias pulse, applied to a predetermined location in the same row and at the same time, whereby the unstable planar state and the unstable focal conic state are displayed simultaneously in at least a partial area of the display during the activating; whereby an stable planar state and an stable focal conic state are displayed simultaneously in at least a partial area of the display by the end of activating process.

2. The driving means according to claim 1 wherein the erasing pulse is a narrow pulse “V_{E}” with amplitude higher than the cholesteric to nematic phase change voltage.

3. The driving means according to claim 1 wherein the addressing pulse is a narrow pulse “V_{A}” with amplitude approximately equal to unstable focal conic state.

4. The driving means according to claim 1 wherein the bias voltage is a controllable voltage “V_{NP}” determining the unstable planar state.

5. The driving means according to claim 1 wherein the unstable planar state is a displayable optical “on” state.

6. The driving means according to claim 1 wherein the unstable focal conic state is a displayable optical “off” state.

7. The driving means according to claim 1 wherein the stable planar state is another displayable optical “on” state.

8. The driving means according to the claim 1 wherein the stable focal conic state is another displayable optical “off” state.

9. The driving means according to the claim 1 wherein at least a partial area addressing means is a whole frame addressing means.

10. The driving means according to claim 1 wherein the partial area means localized addressing means, which allows partial writing or changing the information content based on one pixel, one line or multiple lines, while the rest information contents are maintaining their originals in the display area.

11. The driving means according to claim 10 wherein the localized addressing is handwriting display mode.

12. The driving means according to claim 10 wherein the localized addressing is a typewriting display mode.

13. The driving means according to claim 10 wherein the localized addressing is partial correction display mode.

14. The driving means according to claim 10 wherein the localized addressing is a data input display mode.

15. The driving means according to claim 10 wherein the localized addressing is a word processing display mode.

16. A part of waveform generating circuit comprising:
a. a programmable resisitor, Rₓ;
b. a series fixed resistors R with approximately the same value;
c. a divider circuit with multiple outputs;
d. a DC pulse voltage source, V_{LCD};
The programmable resistor creates variable bias voltage wherein the highest Rₓ represents the lowest bias voltage and vice versa, whereby optimal localized addressing mode and whole frame addressing mode can be automatically or manually convertible.

17. The waveform generating circuit according to claim 16 wherein the multiple outputs are V_{NP}, 2V_{NP}, V_{A}, V_{A}+V_{NP} and V_{E}.

18. The waveform generating circuit according to claim 16 wherein the waveform is governed by the following formulas
V_{E}=V_{LCD}
V_{A}=V_{E}−2V_{NP}
V_{NP}≧V_{T}.

19. The waveform generating circuit according to claim 16 wherein the waveform is coupled to at least one common “X” driver and to at least one segment “Y” driver to composite DC-free AC pulses, V_{NP}, V_{A}, and V_{E}.

20. The waveform generating circuit according to claim 19 wherein the V_{NP}, V_{A}, and V_{E} pulses are non-parasitical driving pulses.
